(19) United States
(12) Patent Application Publication
(10) Pub. No.: US 2009/0044724 A1
(43) Pub. Date: Feb. 19, 2009

(54) COATING COMPOSITIONS CONTAINING MONOMERIC, LONG-CHAIN REACTANTS

(75) Inventors: WALTER H. OHRBOM, HARTLAND TOWNSHIP, MI (US); DAVID K. LAU, ROYAL OAK, MI (US); SERGIO BALATAN, WEST BLOOMFIELD, MI (US); NICHOLAS CAIOZZO, ST. CLAIR SHORES, MI (US); GREGORY G. MENOVCIK, NORTHVILLE, MI (US)

Correspondence Address: Harness, Dickey and Pierce, P.L.C., 5445 Corporate Drive, Troy, MI, 48098, US

(73) Assignee: BASF CORPORATION, SOUTHFIELD, MI (US)

(21) Appl. No.: 11/854,699

(22) Filed: Sep. 13, 2007

Related U.S. Application Data
(63) Continuation of application No. 11/840,411, filed on Aug. 17, 2007.

(51) Int. Cl. C08J 7/00

(52) U.S. Cl. 106/287.24

(57) ABSTRACT

A coating composition is disclosed comprising a binder, the binder comprising a crosslinker, a thermosetting polymer reactive with the crosslinker, and at least 5 percent by binder weight of a compound that (i) is not a crystalline solid at room temperature, (ii) has at least two groups reactive with the crosslinker, (iii) has two to six ester groups, and (iv) comprises 10 to 48 carbon atoms.

### CROSS-REFERENCE TO RELATED APPLICATION

This application claims priority to U.S. patent application Ser. No. 11/840,411, filed Aug. 17, 2007.

### FIELD

The present disclosure concerns coating compositions, especially thermosetting industrial coating compositions for automotive and other major goods.

### BACKGROUND

This section provides background information related to the present disclosure that may or may not be prior art.

Curable coating compositions, especially thermoset coatings, are widely used in the coatings art. They are often used as topcoats in the automotive and industrial coatings industry. Color-plus-clear composite coatings are particularly useful as topcoats where exceptional gloss, depth of color, distinctness of image, or special metallic effects are desired. The automotive industry has made extensive use of these coatings for automotive body panels.

The effect of the coating process on the environment and the effect of the environment on coatings have increasingly shaped the coatings art in the last few decades. The industry has put considerable effort into developing coatings with materials that will be less harmful toward the environment. Examples of coatings that generally contain lower levels of volatile organic compounds include waterborne coatings, powder coatings, and high solids solvent borne coatings.

However, it has been difficult to devise environmentally sensitive coatings that simultaneously provided desirable resistance to environmental degradation and superior finished film performance properties.

For example, color-plus-clear composite coatings require an extremely high degree of clarity and low degree of visual aberrations at the surface of the coating in order to achieve a high distinctness of image (DOI). As a result, these coatings are especially susceptible to a phenomenon known as environmental etch. Environmental etch manifests itself as spots or marks on or in the finish of the coating that often cannot be rubbed out.

It is often difficult to predict the degree of resistance to environmental etch that a high gloss or color-plus-clear composite coating will exhibit. Many coating compositions known for their durability and/or weatherability when used in exterior paints do not provide the desired level of resistance to environmental etch when used in high gloss coatings such as the clearcoat of a color-plus-clear composite coating. Many compositions have been proposed for use as the film-forming component of the clearcoat of a color-plus-clear composite coating. Examples that address the problem of environmental etch resistance include carbamate-aminoplast systems, polyurethanes, acid-epoxy systems and the like. However, several of these prior art systems are vulnerable to application problems.

At the same time, it is desirable to use as little of volatile organic compounds as possible to avoid producing regulated emissions in the coating process. Thus, it would be desirable to prepare a coating composition using materials that are low visclosity, nonvolatile liquids at room temperature or using low melting or waxy solids.

### SUMMARY

A coating composition comprises a binder, comprising a crosslinker, a thermosetting polymer reactive with the crosslinker, and at least 5 percent by weight of the binder of a compound that (i) is not a crystalline solid at room temperature, (ii) has at least two groups reactive with the crosslinker, (iii) has two to six ester groups, and (iv) comprises 10 to 48 carbon atoms. Oligomers are polymers having relatively few monomer units; generally, “oligomer” refers to polymers with ten or fewer monomer units, while “polymers” is used to encompass oligomers as well as polymers with higher numbers of monomer units. “Compounds” will refer to nonpolymeric materials.

In a first embodiment, the noncrystalline compound has two beta-hydroxy ester groups.

In a second embodiment, the noncrystalline compound has two beta-carbamate ester groups.

In a third embodiment, the noncrystalline compound has a hydroxyl group that is not beta to an ester group, a first ester group, and a second ester group that is a beta-hydroxy ester group.

In a fourth embodiment, the noncrystalline compound has a carbamate group that is not beta to an ester group, a first ester group, and a second ester group that is a beta-carbamate ester group.

In a fifth embodiment, the noncrystalline compound has a plurality of beta hydroxy ester groups.

In a sixth embodiment, the noncrystalline compound has a plurality of beta carbamate ester groups.

In a seventh embodiment, the noncrystalline compound has a carbamate group that is not beta to an ester group, a first ester group, and a second ester group that is a beta-hydroxy ester group.

In an eighth embodiment, the noncrystalline compound has a carbamate group that is not beta to an ester group, a first ester group, and a second ester group that is a beta-carbamate ester group.

In a ninth embodiment, the noncrystalline compound has a two carbamate groups that are not beta to an ester group, first and second ester groups, and third and fourth additional ester groups that are beta-hydroxy ester groups.

In a tenth embodiment, the noncrystalline compound has a two carbamate groups that are not beta to an ester group, first and second ester groups, and third and fourth additional ester groups that are beta-carbamate ester groups.

The compositions of the invention exhibit excellent resistance to solvent popping and excellent appearance while maintaining durability. The compositions may be formulated as solventborne coating compositions using less solvent (i.e., at lower volatile organic content).

A method of making a coating composition comprises reacting together a carboxylic acid and an epoxide to make a compound that (i) is not a crystalline solid at room temperature, (ii) has at least two groups reactive with a crosslinker, (iii) has two to six ester groups, and (iv) comprises 10 to 48 carbon atoms, and combining the compound with a crosslinker and a thermosetting polymer reactive with the crosslinker, The carboxylic acid or the epoxide compound may be multifunctional. The hydroxyl groups resulting from the reaction of epoxide and carboxyl may be converted to carbamate groups.

“A” and “an” as used herein indicate “at least one” of the item is present; a plurality of such items may be present, when possible. Other than in the working examples provides at the end of the detailed description, all numerical values of parameters (e.g., of quantities or conditions) in this specification, including the appended claims, are to be understood as being modified in all instances by the term “about.” “About” when applied to values indicates that the calculation or the measurement allows some slight imprecision in the value (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The coating composition comprises a binder, the binder comprising a crosslinker, a thermosetting polymer reactive with the crosslinker, and at least 5 percent by weight of the binder of a compound that (i) is not a crystalline solid at room temperature, (ii) has at least two groups reactive with the crosslinker, (iii) has two to six ester groups, and (iv) comprises 10 to 48 carbon atoms.

In a first embodiment, the noncrystalline compound has two beta-hydroxy ester groups. Beta-hydroxy ester groups may be formed by reaction of a carboxyl group with an epoxide group. In a preferred embodiment, at least one of the carboxyl functional material or the epoxide functional material, or both, comprises a neoalkyl radical. The neoalkyl radical preferably has from eight to about twelve carbon atoms. It is also preferable for the neoalkyl radical to have one methyl group. Neoalkanoic acids may be represented by the general structure

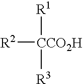

and epoxide esters of neoalkanoic acids may be represented by the general structure

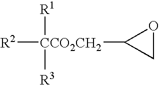

in which R¹, R², and R³ each is a hydrocarbyl radical and R¹, R², and R³ together have from six to twelve carbon atoms; preferably, at least one of R¹, R², and R³ is a methyl group. Neoalkanoic acids from neopentanoic acid to neodecanoic acid are commercially available. A glycidyl ester of neodecanoic acid isomers is commercially available as Cardura E10 from Hexion.

The two beta-hydroxy ester groups may be formed by reaction of a diepoxide with a monocarboxylic acid or by reaction of a dicarboxylic acid with a monoepoxide. Examples of useful reactants include, without limitation, 1,6-hexanedioic acid, fatty acid dimers, 1,5-hexadiene diepoxide, and epoxy esters of branched carboxylic acids. In a more preferred embodiment, the monocarboxylic acid or the monoepoxide has a neoalkyl group having 6 to 12 carbon atoms.

In a second embodiment, the noncrystalline compound has 2 beta-carbamate ester groups. The beta-carbamate ester groups may be formed by first reacting a carboxyl group with an epoxide group to form a beta-hydroxy group, then coverting the hydroxyl group to a carbamate group. Hydroxyl groups may be converted to carbamate groups by a number of ways, including reaction with cyanic acid, which may be generated by decomposition of urea or by other methods, such as described in U.S. Pat. No. 4,389,386 or 4,364,913, or by reaction with methyl carbamate, butyl carbamate, propyl carbamate, 2-ethylhexyl carbamate, cyclohexyl carbamate, phenyl carbamate, hydroxypropyl carbamate, hydroxyethyl carbamate, hydroxybutyl carbamate, and the like at temperatures from room temperature to 150° C., with transesterification catalysts such as calcium octoate, metal hydroxides, such as KOH, Group I or II metals, such as sodium and lithium, metal carbonates, such as potassium carbonate or magnesium carbonate, which may be enhanced by use in combination with crown ethers, metal oxides like dibutyltin oxide, metal alkoxides such as NaOCH₃ and Al(OC₃H₇)₃, metal esters like stannous octoate and calcium octoate, or protic acids such as H₂SO₄ or Ph₄SbI. The transesterification reaction may also be conducted at room temperature with a polymer-supported catalyst such as Amberlyst-15® (Rohm & Haas) as described by R. Anand, Synthetic Communications, 24(19), 2743-47 (1994), the disclosure of which is incorporated herein by reference. Useful carbamate compounds include those having the formula:

R′—O—(C═O)—NHR″

wherein R′ is substituted or unsubstituted alkyl (preferably of one to eight carbon atoms, more preferably of one to four carbon atoms) and R″ is H, substituted or unsubstituted alkyl (preferably of 1-8 carbon atoms, more preferably of one to four carbon atoms), substituted or unsubstituted cycloalkyl (preferably of 6-10 carbon atoms), or substituted or unsubstituted aryl (preferably of 6-10 carbon atoms). Preferably, R″ is H.

In a third embodiment, the noncrystalline compound has a hydroxyl group that is not beta to an ester group, a first ester group, and a second ester group that is a beta-hydroxy ester group. The compound of the second embodiment can be prepared by reaction of one mole of a polyol with one mole of a cyclic anhydride, then reaction of the resulting carboxyl group with an epoxide functional compound. In a preferred embodiment, the epoxide functional compound is a monoepoxide ester of a neoalkanoic acid.

In a fourth embodiment, the noncrystalline compound has a carbamate group that is not beta to an ester group, a first ester group, and a second ester group that is a beta-carbamate ester group. The compound of the fourth embodiment can be prepared by converting the hydroxyl groups of the compound of the third embodiment to carbamate groups, for example by using one of the methods described above.

In a fifth embodiment, the noncrystalline compound has a plurality of beta hydroxy ester groups. The compound of the fifth embodiment may be made either by reaction of a polycarboxylic acid with a monoepoxide compound or by reaction of a polyepoxide with a monocarboxylic acid. In one embodiment, the monocarboxylic acid or the monoepoxide has 6 to 12 carbon atoms.

In a sixth embodiment, the noncrystalline compound has a plurality of beta carbamate ester groups. The compound of the sixth embodiment may be formed by converting the hydroxyl groups of the compound of the fifth embodiment to carbamate groups, for example by using one of the methods described above.

In a seventh embodiment, the noncrystalline compound has a carbamate group that is not beta to an ester group, a first ester group, and a second ester group that is a beta-hydroxy ester group. The compound of the seventh embodiment may be made by reacting a hydroxyalkyl carbamate compound such as hydroxyethyl carbamate or hydroxypropyl carbamate with a cyclic anhydride, then reacting the resulting carboxyl group with an epoxide functional compound. In a preferred embodiment, the epoxide functional compound is a monoepoxide ester of a neoalkanoic acid.

In an eight embodiment, the noncrystalline compound has a carbamate group that is not beta to an ester group, a first ester group, and a second ester group that is a beta-carbamate ester group. The compound of the eighth embodiment may be formed by converting the hydroxyl group of the compound of the seventh embodiment to carbamate groups, for example by using one of the methods described above.

In a ninth embodiment, the noncrystalline compound has a two carbamate groups that are not beta to an ester group, first and second ester groups, and third and fourth additional ester groups that are beta-hydroxy ester groups. The compound of the ninth embodiment may be prepared by reacting a hydroxyalkyl carbamate compound with a dicyclic anhydride, then reacting the resulting carboxyl group with an epoxide functional compound. In a preferred embodiment, the epoxide functional compound is a monoepoxide ester of a neoalkanoic acid.

In a tenth embodiment, the noncrystalline compound has a two carbamate groups that are not beta to an ester group, first and second ester groups, and third and fourth additional ester groups that are beta-carbamate ester groups. The compound of the tenth embodiment may be formed by converting the hydroxyl groups of the compound of the ninth embodiment to carbamate groups, for example by using one of the methods described above.

A method of making a coating composition comprises reacting together a carboxylic acid and an epoxide to make a compound that (i) is not a crystalline solid at room temperature, (ii) has at least two groups reactive with a crosslinker, (iii) has two to six ester groups, and (iv) comprises 10 to 48 carbon atoms, and combining the compound with a crosslinker and a thermosetting polymer reactive with the crosslinker. In a first embodiment of the method, the compound is made by reacting together a dicarboxylic acid and a neoalkyl monoepoxide. Optionally, hydroxyl groups from this reaction step are converted to carbamate groups.

In a first embodiment of the method, the compound is made by reacting together glycidyl ester of a neoalkanoic acid mixture with a polycarboxylic acid. Nonlimiting examples of polycarboxylic acids include phthalic acid, isophthalic acid, terephthalic acid, thioglycolic acid, tricarballylic acid, azeleic acid, trimellitic anhydride, citric acid, malic acid, tartaric acid, citric acid, and adipic acid, as well as anhydrides of the acids.

The hydroxy group-containing product derived from the acid/epoxy ring-opening reaction may then be used as a hydroxyl-functional soft, second material, or the hydroxyl groups may be reacted to produce another functional group. In one example, the hydroxyl groups are reacted with cyanic acid and/or a compound comprising a carbamate group or a urea group in order to form a carbamate-functional soft, second material. Cyanic acid may be formed by the thermal decomposition of urea or by other methods, such as described in U.S. Pat. No. 4,389,386 or 4,364,913. When a compound comprising a carbamate or urea group is utilized, the reaction with the hydroxyl group is believed to be a transesterification between the hydroxyl group and the carbamate or urea group. The carbamate compound can be any compound having a carbamate group capable of undergoing a reaction (esterification) with a hydroxyl group. These include, for example, methyl carbamate, butyl carbamate, propyl carbamate, 2-ethylhexyl carbamate, cyclohexyl carbamate, phenyl carbamate, hydroxypropyl carbamate, hydroxyethyl carbamate, hydroxybutyl carbamate, and the like. Useful carbamate compounds can be characterized by the formula:

R′—O—(C═O)—NHR″

wherein R′ is substituted or unsubstituted alkyl (preferably of one to eight carbon atoms, more preferably of one to four carbon atoms) and R″ is H, substituted or unsubstituted alkyl (preferably of 1-8 carbon atoms, more preferably of one to four carbon atoms), substituted or unsubstituted cycloalkyl (preferably of 6-10 carbon atoms), or substituted or unsubstituted aryl (preferably of 6-10 carbon atoms). Preferably, R″ is H.

Urea groups can generally be characterized by the formula

R′—NR—(C═O)—NHR″

wherein R and R″ each independently represents H or alkyl, preferably of 1 to 4 carbon atoms, or R and R″ may together form a heterocyclic ring structure (e.g., where R and R″ form an ethylene bridge), and wherein R′ represents a substituted or unsubstituted alkyl (preferably of one to eight carbon atoms, more preferably of one to four carbon atoms).

The transesterification reaction between the carbamate or urea and the hydroxyl group-containing compounds can be conducted under typical transesterification conditions, for example temperatures from room temperature to 150° C., with transesterification catalysts such as calcium octoate, metal hydroxides, such as KOH, Group I or II metals, such as sodium and lithium, metal carbonates, such as potassium carbonate or magnesium carbonate, which may be enhanced by use in combination with crown ethers, metal oxides like dibutyltin oxide, metal alkoxides such as NaOCH₃ and Al(OC₃H₇)₃, metal esters like stannous octoate and calcium octoate, or protic acids such as H₂SO₄ or Ph₄SbI. The reaction may also be conducted at room temperature with a polymer-supported catalyst such as Amberlyst-15® (Rohm & Haas) as described by R. Anand, Synthetic Communications, 24(19), 2743-47 (1994), the disclosure of which is incorporated herein by reference.

The ring-opening of the oxirane ring of an epoxide compound by a carboxylic acid results in a hydroxy ester structure. Subsequent transesterification of the hydroxyl group on this structure by the carbamate compound results in a carbamate-functional component.

Two different kinds of functional groups may be present on the compound. In one preferred embodiment, the reaction product of the epoxide functional compound and the organic acid has a plurality of hydroxyl groups per compound and, on average, less than all of the hydroxyl groups are reacted with the cyanic acid or the compound comprising a carbamate or urea group. In a particularly preferred embodiment, the reaction product of the epoxide-functional compound and the neolkanoic acid has from about two to about four hydroxyl groups per molecule and only part of these groups, on average, are reacted to form a carbamate group or urea group on the compound of soft, second material. In another preferred embodiment, the precursor product of the reaction of the epoxide-functional compound with the neoalkanoic acid has residual acid groups resulting from reaction of a stoichiometric excess of acid groups. The hydroxyl groups formed are then reacted with the cyanic acid or the compound comprising a carbamate or urea group to form a compound of component (a) having a carbamate or urea functionality as well as epoxide or acid functionality.

In a second embodiment of the method, the compound is made by reacting together a diol with a cyclic anhydride to form a dicarboxylic acid, then reacting the dicarboxylic acid with a neoalkyl monoepoxide. Optionally, hydroxyl groups from the epoxide reaction step are converted to carbamate groups.

In this second embodiment, suitable nonlimiting diols include diols with 2-18 carbon atoms such as 1,3-propanediol, 1,2-ethanediol, 1,4-butanediol, 1,5-pentanediol, 1,6-hexanediol, dimethylolpropane, neopentyl glycol, 2-propyl-2-methyl-1,3-propanediol, 2-butyl-2-ethyl-1,3-propanediol, 2,2-diethyl-1,3-propanediol, 2,2,4-trimethylpentane-1,3-diol, trimethylhexane-1,6-diol, 2-methyl-1,3-propanediol, diethylene glycol, triethylene glycol, polyethylene glycols, dipropylene glycol, tripropylene glycol and polypropylene glycols. Cycloaliphatic diols such as cyclohexane dimethanol and cyclic formals of pentaerythritol such as, for instance, 1,3-dioxane-5,5-dimethanol can also be used. Aromatic diols, for instance 1,4-xylylene glycol and 1-phenyl-1,2-ethanediol, as well as reaction products of polyfunctional phenolic compounds and alyklene oxides or derivatives thereof, can furthermore be employed. Bisphenol A, hydroquinone, and resorcinol may also be used.

The diol is reacted with a cyclic anhydride. Suitable cyclic anhydrides include, without limitation, maleic anhydride, succinic anhydride, phthlalic anhydride, hexahydrophthalic anhydride, tetrahydrophthalic anhydride, methyl tetrahydrophthalic anhydride, methylhexahydrophthalic anhydride, trimellitic anhydride, adipic anhydride, glutaric anhydride, malonic anhydride, and the like. The anhydride may have non-reactive substituents, including alkyl groups.

The diol and the cyclic anhydride are preferably reacted in a molar ratio of about 1:1, so that a carboxyl group is generated from the anhydride in the reaction product for each hydroxyl group of the diol. This intermediate reaction product is then reacted with a mixture of monoepoxide esters of the fatty acid homologs and/or isomers, preferably with a mixture of glycidyl esters of neoalkanoic acids. The product is a hydroxyl-functional second, soft material.

The hydroxyl groups of the product may be converted to carbamate groups. A carbamate functional compound of this second embodiment may be prepared by reaction of the hydroxyl functional material just described with a low molecular weight carbamate functional monomer such as methyl carbamate under appropriate reaction conditions. Alternatively, carbamate groups can be formed by the decomposition of urea in the presence of the hydroxyl functional material. Finally, a carbamate compound can be obtained via the reaction of phosgene with the hydroxyl groups, followed by reaction with ammonia.

In a third embodiment of the method, the compound is made by reacting together a polyepoxide compound with a neoalkyl carboxylic acid. Suitable polyepoxide compounds include, without limitation, diepoxides such as epoxidized alkadienes such as 1,5-hexadiene, 1,7-octadiene, and 1,1-dodecadiene and epoxidized polycarboxylic acids such as 1,12-dodecanedioic acid and dimer fatty acids; mixtures of di- and tri-glycidyl ester resulting from reaction of epichlorohydrin with trimer fatty acid; and low molecular weight epoxide-functional oligomers such as epoxidized unsaturated oils such as epoxidized soy oil, epoxided unsaturated fatty acid dimers, an depoxidezed fatty acid trimers. The reaction of the fatty or neoalkyl acids with the epoxide groups of the polyepoxide produces beta-hydroxy ester groups.

Optionally, hydroxyl groups from this reaction step are converted to carbamate groups. Carbamate groups may be produced by reaction of the hydroxyl groups with a low molecular weight carbamate functional monomer such as methyl carbamate. Alternatively, carbamate groups may be made by decomposition of urea in the presence of the hydroxyl functional compound. Finally, carbamate functional compound can be obtained via the reaction of phosgene with the hydroxyl groups, followed by reaction with ammonia.

In a fourth embodiment of the method, the compound is made by reacting together a hydroxyalkyl carbamate compound and a cyclic anhydride to prepare a compound having a carbamate group and a carboxylic acid group, then reacting the compound having a carbamate group and a carboxylic acid group with a neoalkyl monoepoxide. This reaction produces hydroxyl groups, with may again optionally be converted to other functional groups such as carbamate groups, as outlined for the previous example. A carbamate group is also provided by the hydroxyalkyl carbamate.

In a fifth embodiment of the method, a di-cyclic carboxylic anhydride is reacted with a hydroxyalkyl carbamate compound to prepare a compound having two carbamate groups and two carboxylic acid groups. Nonlimiting examples of di-cyclic carboxylic anhydride include pyromellitic dianhydride, ethylenediaminetetraacetic dianhydride, cyclobutane-1,2,3,4-tetracarboxylic dianhydride, 3,3′,4,4′-biphenyltetracarboxylic dianhydride, tetrahydrofurane-2,3,4,5-tetracarboxylic dianhydride, cyclohexane-1,2,4,5-tetracarboxylic acid dianhydride, and 3,3′-(1,2-ethanediyl)bis[dihydro-2,5-furandione. Then the compound having two carbamate groups and two carboxylic acid groups is reacted with a neoalkyl monoepoxide. Optionally, hydroxyl groups from the epoxide reaction step are converted to carbamate groups by methods already described.

In certain preferred embodiments of the coating compositions and methods, a neodecanoic acid a glycidyl ester of a neodecanoic acid is employed.

The noncrystalline compound is present in the coating composition in an amount of from 5 to 95, more preferably from 10 to 85, and most preferably from 20 to 80, all % by weight based on the total nonvolatile weight of the film-forming components (binder) of the curable composition.

The binder also comprises a thermosetting polymer and a crosslinker. Non-limiting examples of thermosetting polymers include vinyl polymers such as acrylic polymers and modified acrylic polymers, polyesters, polyurethanes, epoxy resins, polycarbonates, polyamides, polyimides, polysiloxanes, and mixtures thereof, all of which are known in the art. The thermosetting polymer has groups reactive with the crosslinker, such as, without limitation, hydroxyl groups, carbamate groups, terminal urea groups, carboxyl groups, epoxide groups, amino groups, thiol groups, hydrazide groups, activated methylene groups, and any combinations thereof that may be made in a thermosettable polymer.

In one preferred embodiment of the invention, the polymer is an acrylic. The acrylic polymer preferably has a molecular weight of 500 to 1,000,000, and more preferably of 1500 to 50,000. As used herein, “molecular weight” refers to number average molecular weight, which may be determined by the GPC method using a polystyrene standard. Such polymers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such polymers include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

Modified acrylics can also be used as the film-forming thermosetting polymer in the coating compositions. Such acrylics may be polyester-modified acrylics or polyurethane-modified acrylics, as is well known in the art. Polyester-modified acrylics modified with □-caprolactone are described in U.S. Pat. No. 4,546,046 of Etzell et al, the disclosure of which is incorporated herein by reference. Polyurethane-modified acrylics are also well known in the art. They are described, for example, in U.S. Pat. No. 4,584,354, the disclosure of which is incorporated herein by reference.

Polyesters having active hydrogen groups such as hydroxyl groups can also be used as the polymer in the coating composition. Such polyesters are well known in the art, and may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

Polyurethanes having active hydrogen functional groups are also well known in the art. They are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). They can be provided with active hydrogen functional groups by capping the polyurethane chain with an excess of diol, polyamine, amino alcohol, or the like.

Carbamate functional polymers and oligomers can also be used as thermosetting polymer, especially those having at least one primary carbamate groups.

Carbamate functional examples of the thermosetting polymer used in the coating compositions can be prepared in a variety of ways. One way to prepare such polymers is to prepare an acrylic monomer having carbamate functionality in the ester portion of the monomer. Such monomers are well known in the art and are described, for example in U.S. Pat. Nos. 3,479,328, 3,674,838, 4,126,747, 4,279,833, and 4,340,497, 5,356,669, and WO 94/10211, the disclosures of which are incorporated herein by reference. One method of synthesis involves reaction of a hydroxy ester with urea to form the carbamyloxy carboxylate (i.e., carbamate-modified acrylic). Another method of synthesis reacts an □.□-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically unsaturated monomers, if desired, by techniques well known in the art.

An alternative route for preparing the thermosetting polymer of the binder is to react an already-formed polymer such as an acrylic polymer or polyurethane polymer with another component to form a carbamate-functional group appended to the polymer backbone, as described in U.S. Pat. No. 4,758,632. One technique for preparing such polymers involves thermally decomposing urea (to give off ammonia and HNCO) in the presence of a hydroxy-functional acrylic polymer to form a carbamate-functional polymer. Another technique involves reacting the hydroxyl group of a hydroxyalkyl carbamate with the isocyanate group of an isocyanate-functional polymer to form the carbamate-functional polymer. Isocyanate-functional acrylics are known in the art and are described, for example in U.S. Pat. No. 4,301,257, the disclosure of which is incorporated herein by reference. Isocyanate vinyl monomers are well known in the art and include unsaturated m-tetramethyl xylene isocyanate (sold by American Cyanamid as TMI®). Isocyanate-functional polyurethanes may be formed by using an equivalent excess of diisocyanate or by end-capping a hydroxyl-functional prepolymer with a polyisocyanate. Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514, the disclosure of which is incorporated herein by reference. Another technique is to transcarbamylate a hydroxy-functional polymer with an alkyl carbamate. A more difficult, but feasible way of preparing the polymer would be to trans-esterify with a hydroxyalkyl carbamate.

The carbamate content of the polymer, on a weight per equivalent of carbamate functionality, will generally be between 200 and 1500, and preferably between 300 and 500.

The binder of the coating compositions further comprise a crosslinker. Crosslinkers may be used in amounts of from 1 to 90%, preferably from 3 to 75%, and more preferably from 25 to 50%, all based on the total binder of the coating composition.

The functional groups of the crosslinker are reactive with the functional groups of the polymer, and, preferably, with the non-crystalline compound also. Preferably, the reaction between the crosslinker and polymer form irreversible linkages. Examples of functional group “pairs” producing thermally irreversible linkages are hydroxy/isocyanate (blocked or unblocked), hydroxy/epoxy, carbamate/aminoplast, carbamate/aldehyde, acid/epoxy, amine/cyclic carbonate, amine/isocyanate (blocked or unblocked), urea/aminoplast, and the like.

illustrative polymer functional groups include carboxyl, hydroxyl, aminoplast functional groups, urea, carbamate, isocyanate, (blocked or unblocked), epoxy, cyclic carbonate, amine, aldehyde and mixtures thereof. Preferred polymer functional groups are hydroxyl, primary carbamate, isocyanate, aminoplast functional groups, epoxy, carboxyl and mixtures thereof. Most preferred polymer functional groups are hydroxyl, primary carbamate, and mixtures thereof. These preferences pertain regardless of whether a thermally reversible or irreversible linkage is desired. It will be appreciated by those of skill in the art that it is the selection of a corresponding reactable functional groups in either the polymer or crosslinker that determine whether resulting linkages will be thermally reversible or irreversible.

The coating composition in certain embodiments includes an aminoplast as a crosslinker. An aminoplast for purposes of the invention is a material obtained by reaction of an activated nitrogen with a lower molecular weight aldehyde, optionally further reacted with an alcohol (preferably a mono-alcohol with one to four carbon atoms) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups.

The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred. The etherification may be carried out, for example, by the processes disclosed in U.S. Pat. Nos. 4,105,708 and 4,293,692, the disclosures of which are incorporated herein by reference.

It is preferred for the aminoplast to be at least partially etherified, and especially preferred for the aminoplast to be fully etherified. The preferred compounds have a plurality of methylol and/or etherified methylol groups, which may be present in any combination and along with unsubstituted nitrogen hydrogens. Fully etherified melamine-formaldehyde resins are particularly preferred, for example and without limitation hexamethoxymethyl melamine. Aminoplast crosslinkers react with carbamate, terminal urea, and hydroxyl containing polymers and non-crystalline compounds.

The curable coating composition in certain embodiments includes a polyisocyanate or blocked polyisocyanate crosslinker. Useful polyisocyanate crosslinkers include, without limitation, isocyanurates, biurets, allophanates, uretdione compounds, and isocyanate-functional prepolymers such as the reaction product of one mole of a triol with three moles of a diisocyanate. The polyisocyanate may be blocked with lower alcohols, oximes, or other such materials that volatilize at curing temperature to regenerate the isocyanate groups.

An isocyanate or blocked isocyanate is may be used in 0.1-1.1 equivalent ratio, more preferably from 0.5-1.0 equivalent ratio to the amount of functional groups reactive therewith available from the crosslinkable materials.

For example, when the functional groups of either polymer or noncrystalline component are hydroxyl, functional groups of the crosslinker may be selected from the group consisting of isocyanate (blocked or unblocked), epoxy, and mixtures thereof, and most preferably will be isocyanate groups, whether blocked or unblocked.

Illustrative examples of epoxide functional crosslinkers are all known epoxy functional polymers and oligomers. Preferred epoxide functional crosslinking agents are glycidyl methacrylate polymers and isocyanurate containing epoxide functional materials such as trisglycidyl isocyanurate and the reaction product of glycidol with an isocyanate functional isocyanurate such as the trimer of isophorone diisocyanate (IPDI). Polyepoxide functional crosslinkers are suitable for use with carboxyl functional polymers.

Pigments and fillers may be utilized in amounts typically of up to about 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like.

The coating composition may include a catalyst to enhance the cure reaction. Such catalysts are well-known in the art and include, without limitation, zinc salts, tin salts, blocked para-toluenesulfonic acid, blocked dinonylnaphthalenesulfonic acid, or phenyl acid phosphate. The coating composition used in the practice of the invention may include a catalyst to enhance the cure reaction. For example, when aminoplast compounds, especially monomeric melamines, are used as a curing agent, a strong acid catalyst may be utilized to enhance the cure reaction. Such catalysts are well-known in the art and include, without limitation, p-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. Other catalysts that may be useful in the composition of the invention include Lewis acids, zinc salts, and tin salts.

A solvent or solvents may be included in the coating composition. In general, the solvent can be any organic solvent and/or water. In one preferred embodiment, the solvent includes a polar organic solvent. More preferably, the solvent includes one or more organic solvents selected from polar aliphatic solvents or polar aromatic solvents. Still more preferably, the solvent includes a ketone, ester, acetate, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents. In general, protic solvents such as alcohol and glycol ethers are avoided when the coating composition includes the optional polyisocyanate crosslinker, although small amounts of protic solvents can be used even though it may be expected that some reaction with the isocyanate groups may take place during curing of the coating.

Additional agents, for example hindered amine light stabilizers, ultraviolet light absorbers, anti-oxidants, surfactants, stabilizers, wetting agents, rheology control agents, dispersing agents, adhesion promoters, etc. may be incorporated into the coating composition. Such additives are well-known and may be included in amounts typically used for coating compositions.

The coating compositions can be coated on a substrate by spray coating. Electrostatic spraying is a preferred method. The coating composition can be applied in one or more passes to provide a film thickness after cure of typically from about 20 to about 100 microns.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

After application of the coating composition to the substrate, the coating is cured, preferably by exposing the coating layer to heat for a length of time sufficient to cause the reactants to form an insoluble polymeric network. The cure temperature is usually from about 105° C. to about 175° C., and the length of cure is usually about 15 minutes to about 60 minutes. Preferably, the coating is cured at about 120° C. to about 150° C. for about 20 to about 30 minutes.

In one embodiment, the coating composition is utilized as the clearcoat of an automotive composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Preferred crosslinkable functional groups include hydroxy functional groups and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The clearcoat coating composition is generally applied wet-on-wet over a basecoat coating composition as is widely done in the industry. The coating compositions are preferably subjected to conditions so as to cure the coating layers as described above.

The coating composition may also be utilized as a one-layer topcoat or as a basecoat coating. A one-layer topcoat or basecoat coating composition includes one or more of the pigments mentioned above, and provides the color and/or metallic effect. A basecoat coating of the invention may be used with a clearcoat coating composition such as those described in the art, including those containing film forming materials with hydroxyl, carboxyl, epoxide, and/or carbamate groups and crosslinkers including aminoplasts, polyisocyanates, polyepoxides, and polycarboxylic acids.

The invention is further described in the following example. The example is merely illustrative and does not in any way limit the scope of the invention as described and claimed. All parts are parts by weight unless otherwise noted.

### EXAMPLES

### Preparation 1

A mixture of 8.9 parts of methyl carbamate and 17.2 parts of Aromatic S-100 was heated under an inert atmosphere to 140° C. Then a mixture of 12.5 parts of hydroxyethyl methacrylate, 7.2 parts of hydroxypropyl methacrylate, 14.8 parts of cyclohexyl methacrylate, 1 part of ethylhexyl acrylate, 0.1 part of methacrylic acid and 5 parts of Perkadox AMBM-GR (obtained from Akzo Nobel) was added over four hours. Next, a mixture of 1.1 parts of toluene and 0.3 parts of Perkadox AMBM-GR is added over 15 minutes. Then 1.1 parts of toluene was added. The reaction mixture was then held at 140° C. for 2 hours and 15 minutes. The reaction mixture was then cooled, and 0.2 parts of dibutyl tin oxide, 0.36 parts of triisodecyl phosphate and 16.5 parts of toluene were added. The reaction mixture was then heated to reflux under an inert atmosphere. Once at reflux, the inert atmosphere was turned off and a methanol/toluene aztrotope was removed from the reaction mixture. After at least 95% of the hydroxy groups were converted to primary carbamate groups, the excess methyl carbamate and toluene were removed by vacuum distillation. The reaction product was then cooled and 13.8 parts of propanediol monomethyl ether were added.

### Preparation 2

A mixture of 16.1 parts of dodecanediodic acid and 16.3 parts of xylene was heated under an inert atmosphere to 130° C. Then 34 parts of Cardura E10P (obtained from Hexion) were slowly added. The reaction mixture was then heated to no more than 140° C. Once the reaction was complete, the reaction mixture was cooled to at least 100° C. and 13.6 parts of methyl carbamate, 0.28 parts of dibutyl tin oxide, 0.57 parts of triisodecyl phosphate and 9.5 parts of toluene were added. The reaction mixture was then heated to reflux. Once at reflux, the inert atmosphere was turned off and a methanol/toluene aztrotope was removed from the reaction mixture. After at least 95% of the hydroxy groups were converted to primary carbamate groups, the excess methyl carbamate and toluene was removed by vacuum distillation. The product had a measured Mₙ of 933, M_{w} of 1301, and polydispersity of 1.4.

### Preparation 3

A mixture of 19.5 parts of amyl acetate and 37 parts of Desmodur Z4470SN (obtained from Bayer) was heated to 60° C. under an inert atmosphere. Then 0.013 parts of dibutyl tin dilaurate and 1 part of amyl acetate were added. Next, 12.1 parts of hydroxypropyl carbamate were slowly added. During the addition, the reaction temperature was allowed to increase to 80° C. Then 1.7 parts of amyl acetate were added and the reaction mixture held at 80° C. until all of the hydroxypropyl carbamate was reacted. Then 0.5 parts of butanol, 19.1 parts of amyl acetate and 4.2 parts of isobutanol were added.

Coating compositions were prepared using the materials of Preparations 1-3, and compared to a commercially available clearcoat coating composition, R10CG062, Batch # 0101636094.

### Example 1

A coating composition was prepared by combining 309.3 parts by weight. of the resin of Preparation 2, 203.4 parts by weight of the resin of Preparation 3, 184.7 parts by weight of RESIMENE 747 (available from Solutia Inc.), 136.5 parts by weight of fumed silica dispersed in an acrylic resin having carbamate functionality, 6.6 parts by weight of hydroxyphenyl triazine ultraviolet light absorber, 14.2 parts by weight of an acrylated hindered amine light stabilizer, 1.7 parts by weight of a polyacrylate anti-pop polymer, 79.4 parts by weight of a blocked acid catalyst solution, 1.3 parts by weight of a polysiloxane solution, 48.5 parts by weight hydroxyphenyl benzotriazole solution, and 14.5 parts by weight n-butanol.

### Example 2

A coating composition was prepared by combining 223.3 parts by weight. of the resin of Preparation 1, 200.9 parts by weight of the resin of Preparation 2, 227.4 parts by weight of fully methylated melamine formaldehyde resin, 141.6 parts by weight of fumed silica dispersed in an acrylic resin having carbamate functionality, 6.9 parts by weight of hydroxyphenyl triazine ultraviolet light absorber, 14.7 parts by weight of an acrylated hindered amine light stabilizer, 1.7 parts by weight of a polyacrylate anti-pop polymer, 82.4 parts by weight of a blocked acid catalyst solution, 1.3 parts by weight of a polysiloxane solution, 50.3 parts by weight hydroxyphenyl benzotriazole solution, and 39.3 parts by weight n-butanol.

The physical properties of the example coating compositions of Examples 1 and 2 were compared to the control. The measurements are shown in the following table.

| | Wt. % | | | |
|---|---|---|---|---|
| Composition | Nonvolatiles | Wt./Gal. | Viscosity (cp) | VOC |
| Example 1 | 63.7 | 8.55 | 121 | 3.10 |
| Example 2 | 63.0 | 8.38 | 120 | 3.10 |
| R10CG062 | 52.1 | 8.26 | 110 | 3.96 |

### Testing of Coating Compositions

The clearcoat coating compositions of Examples 1 and 2 and control example R10CG062 were applied by air atomization wet-on-wet over a commercial waterborme basecoat composition (E54 KW401, obtained from BASF Corp., applied for a cured film thickness of 0.6 to 0.8 mil) to a clearcoat film thickness of about 1.6 to 1.9 mils. The applied coating layers were cured at about 280° F. (137° C.) for about 20 minutes.

STM Test Methods used to obtain the data shown are: Q-Sun Test—D7356, 20° Gloss—D523, Tukon Hardness—D1474, Weight per Gallon—D3363-74, and Weight Non-Volatile—D1475, QCT—D4585. SAE Test Methods used to obtain data shown are: QUV—J2020 with 8 hours UV, 4 hours humidity, and WOM—J1960. Other tests procedures are: CROCKMETER—An Atlas A.A.T.C.C. Crockmeter mounted with a ⅝″ dowel covered with felt and 9 μm 3M 281Q WETODRY polishing paper, was used to abrade the coating surface with ten (10) double strokes. The % Gloss Retention after testing was then calculated for the tested surface area. XYLENE DOUBLE RUB TEST—A 32 oz. Ball Peen Hammer head was covered with a 4 layer thick 4″×4″ cheesecloth, soaked in xylenes, and drawn across and back over the same area for each double rub.

The results of testing the example coating compositions of Examples 1 and 2 and the control are shown in following tables.

| | | | | 3000 hr | |
|---|---|---|---|---|---|
| | | 9 Mic | 50 xylene | QUV % | 3500 hr |
| | | Crockmeter % | doublerubs | Gloss | WOM % |
| | 20° | Gloss | (5-best, | reten- | Gloss |
| Composition | Gloss | retention | 4 = pass) | tion | retention |
| Example 1 | 88 | 88 | 5 | 78 | 99 |
| Example 2 | 90 | 91 | 5 | 10 | 89 |
| R10CG062 | 88 | 81 | 5 | 65 | 98 |

| | 2 day 140° F. QCT | | Q-Sun |
|---|---|---|---|
| | Pre-test adhesion | | 400 hr. |
| | loss/post-test adhesion | | rating (lower |
| Composition | loss | Comments | is better) |
| Example 1 | 0/0 | OK | 6 |
| Example 2 | 0/0 | OK | 6 |
| R10CG062 | 0/0 | OK | 5 |

The testing results in the tables above demonstrate that the inventive coatings are as durable, and perform as well or better than the conventional clear coat, R10CG062. The inventive coatings have good properties with the benefit of lower environmental impact.

The invention has been described in detail with reference to preferred embodiments thereof. It should be understood, however, that variations and modifications can be made within the spirit and scope of the invention and of the following claims.

What is claimed is:

1. A coating composition comprising a binder, the binder comprising a crosslinker, a thermosetting polymer reactive with the crosslinker, and at least 5 percent by weight of the binder of a compound that (i) is not a crystalline solid at room temperature, (ii) has at least two groups reactive with the crosslinker, (iii) has two to six ester groups, and (iv) comprises 10 to 48 carbon atoms.

2. A coating composition according to claim 1, wherein the non-crystalline compound has two beta-hydroxy ester groups.

3. A coating composition according to claim 1, wherein the non-crystalline compound has two beta-carbamate ester groups.

4. A coating composition according to claim 1, wherein the non-crystalline compound has a hydroxyl group that is not beta to an ester group, a first ester group, and a second ester group that is a beta-hydroxy ester group.

5. A coating composition according to claim 1, wherein the non-crystalline compound has a carbamate group that is not beta to an ester group, a first ester group, and a second ester group that is a beta-carbamate ester group.

6. A coating composition according to claim 1, wherein the non-crystalline compound has a plurality of beta hydroxy ester groups.

7. A coating composition according to claim 1, wherein the non-crystalline compound has a plurality of beta carbamate ester groups.

8. A coating composition according to claim 1, wherein the non-crystalline compound has a carbamate group that is not beta to an ester group, a first ester group, and a second ester group that is a beta-hydroxy ester group.

9. A coating composition according to claim 1, wherein the non-crystalline compound has a carbamate group that is not beta to an ester group, a first ester group, and a second ester group that is a beta-carbamate ester group.

10. A coating composition according to claim 1, wherein the non-crystalline compound has a two carbamate groups that are not beta to an ester group, first and second ester groups, and third and fourth additional ester groups that are beta-hydroxy ester groups.

11. A coating composition according to claim 1, wherein the non-crystalline compound has a two carbamate groups that are not beta to an ester group, first and second ester groups, and third and fourth additional ester groups that are beta-carbamate ester groups.

12. A method of making a coating composition, comprising reacting together a carboxylic acid compound and an epoxide compound to make a compound that (i) is not a crystalline solid at room temperature, (ii) has at least two groups reactive with a crosslinker, (iii) has two to six ester groups, and (iv) comprises 10 to 48 carbon atoms, and combining the compound with a crosslinker and a thermosetting polymer reactive with the crosslinker,

13. A method according to claim 12, wherein the carboxylic acid compound is multifunctional.

14. A method according to claim 12, wherein the epoxide compound is multifunctional.

15. A method according to claim 12, wherein hydroxyl group or groups resulting from reaction of the carboxylic acid compound and the epoxide compound are converted to carbamate group or groups.

16. A method according to claim 12, wherein the carboxylic acid compound is a neoalkanoic acid.

17. A method according to claim 16, wherein the carboxylic acid compound is neodecanoic acid.

18. A method according to claim 12, wherein the epoxide compound is an epoxide ester of a neoalkanoic acid.

19. A method according to claim 18, wherein the epoxide compound is an epoxide ester of neodecanoic acid.

20. A method according to claim 12, wherein the carboxylic acid compound is the reaction product of a hydroxyalkyl carbamate and a cyclic anhydride.

21. A method according to claim 12, wherein the carboxylic acid compound is the reaction product of a hydroxyalkyl carbamate and a di-cyclic anhydride.

22. A method according to claim 12, wherein the carboxylic acid compound is the reaction product of a polyol and a cyclic anhydride.
